(19) United States
(12) Patent Application Publication
(10) Pub. No.: US 2021/0187843 A1
(43) Pub. Date: Jun. 24, 2021

(54) PRINT HEADS FOR 3D PRINTERS

(71) Applicants: Krzysztof Wilk, Mystowice (PL); Przemystaw Wolnicki, Ktobuck (PL); Filip Turzynski, Sopot (PL); Bartosz Janus, Piekary Slaskie (PL)

(72) Inventors: Krzysztof Wilk, Mystowice (PL); Przemystaw Wolnicki, Ktobuck (PL); Filip Turzynski, Sopot (PL); Bartosz Janus, Piekary Slaskie (PL)

(21) Appl. No.: 16/795,633

(22) Filed: Feb. 20, 2020

(30) Foreign Application Priority Data
Dec. 18, 2019 (EU) EP19461617.3

(51) Int. Cl. B29C 64/209; B29C 64/321; B29C 64/295

(52) U.S. Cl. CPC B29C 64/209; B33Y 30/00; B29C 64/295; B29C 64/321

(57) ABSTRACT

Print heads for 3D printers are disclosed. The print heads include a head body, which includes an internal cold zone and an internal hot zone. In addition, the print heads include a print nozzle and a tube within the head body, with the tube being configured to receive and transport a printing material from a source within a 3D printer to the print nozzle. The tube spans the cold zone and the hot zone—and does not include any joints or locations at which separate tubes connect. The print heads further include a heating block, which is attached to the head body within the hot zone. In addition, the print heads include a screen that encapsulates the heating block.

### CROSS-REFERENCE TO RELATED APPLICATIONS

This application claims priority to, and incorporates by reference, E.U. patent application number EP19461617.3, filed Dec. 18, 2019.

### FIELD OF THE INVENTION

The field of the present invention relates to three-dimensional (3D) printing and, more particularly, to print heads used in connection with 3D printers.

### BACKGROUND OF THE INVENTION

The print heads in 3D printers play a key role in creating and depositing layers of modeling printing material (according to defined arrangements), to produce a desired spatial model. The printing material typically exists in a filament form—and, during a 3D printing process, the printing material is plasticized and extruded from the print head to create a spatial model. There are various known ways for configuring and constructing print heads, which vary in design, range of operating temperatures, internal construction, and printing material compatibility (particularly with those 3D printers that accommodate plasticized printing materials).

Most currently-available print heads include a printing nozzle (the aperture through which printing material is extruded) having a diameter up to 1 mm, or more preferably up to 0.4 mm. In such 3D printers, a hot zone exists in which the printing material is plasticized, with the hot zone being preceded by a cold zone in which the printing material is not plasticized. Many currently-available print heads further include a polytetrafluoroethylene (PTFE) tube, which is used to guide printing material through the hot zone (but not the cold zone). Such PTFE tubes have been found to impart low friction to the plasticized printing material and to thermally insulate the melted printing material from print head body.

Although the use of PTFE tubes have been somewhat effective, such PTFE tubes do have some disadvantages, particularly with respect to the internal construction of the print head. More particularly, when a print head includes a PTFE tube inside the hot zone, the PTFE tube is often contiguously coupled to a preceding second tube made of another/different material. The second tube is positioned to travel through the preceding cold zone and is often made of a material other than PTFE for a variety of reasons. This type of arrangement and construction sometimes leads to printing material leaks at the joint (i.e., contact point) between the PTFE tube (hot zone) and second preceding tube (cold zone). In addition, the temperature resistance properties of PTFE tubes often do not exceed 270-degrees Celsius, which is too low when it is desired to utilize more specialized printing materials (such as polyether ether ketone or polycarbonate printing materials).

Accordingly, in view of the foregoing, it would be desirable to provide a print head for 3D printers that overcomes such disadvantages with currently-available print heads and, specifically, can reliably operate at higher temperatures (such as over 400-degrees Celsius) and, still more preferably, is compatible with a wide variety of printing materials, including metal and polymer composite printing materials.

As the following will demonstrate, the print heads and components thereof described herein address such demands in the marketplace (among others).

### SUMMARY OF THE INVENTION

According to certain aspects of the invention, print heads for 3D printers are provided. The print heads generally include a head body, which includes an internal cold zone and hot zone. The print heads include a print nozzle and a tube within the head body. The tube is configured to receive and transport a printing material from a source within the 3D printer to the print nozzle. The invention provides that the tube spans the entire length of the cold zone and the hot zone and, importantly, does not include any joints or locations at which separate tubes connect. The invention provides that the tube and the print nozzle are integrally formed together from a single piece of material—and are preferably made from a metallic material.

The print heads further include a heating block attached to the head body. In addition, the invention provides that the heating block is directly connected to the body of the print nozzle. According to such aspects of the invention, the print heads include a screen positioned around the heating block, which is configured to provide thermal insulation to a spatial model being printed below the print head. The screen is preferably made of a material with high thermal radiation insulation capacity. The print heads of the present invention further include one or more vents that are positioned and configured to deliver air flow to a portion of the tube that resides within the cold zone.

According to additional aspects of the invention, 3D printers are provided that include the print heads described herein.

The above-mentioned and additional features of the present invention are further illustrated in the Detailed Description contained herein.

### BRIEF DESCRIPTION OF THE FIGURES

FIG. 1 is a cross-sectional view of a print head of the present invention, for use in 3D printers.

FIG. 2 is a side exterior view of the print head of FIG. 1.

FIG. 3 is an oblique exterior view of the print head of FIG. 1.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

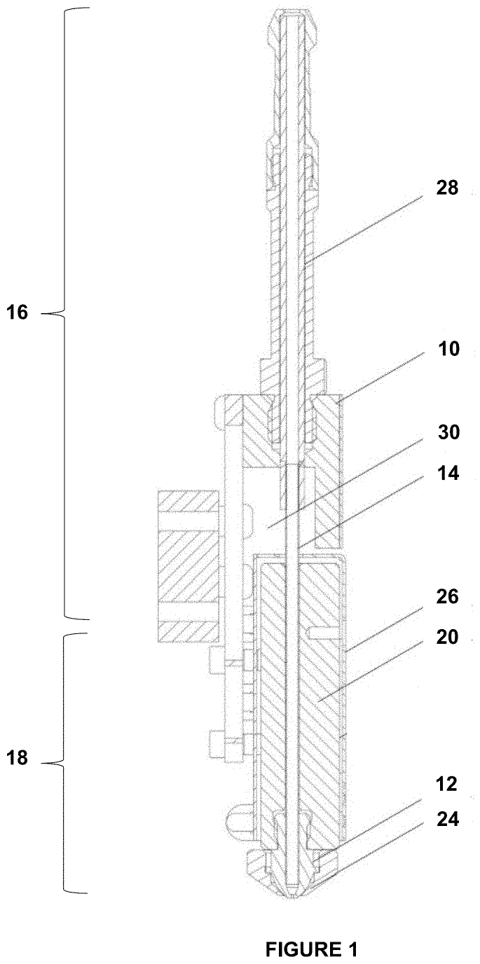

Referring now to FIGS. 1-3, the present invention relates to print heads used in connection with 3D printers (as well as 3D printers that are equipped with such print heads). In such embodiments, the print heads of the present invention generally include a head body 10, a print nozzle 12, and a seamless/joint-free tube 14 for leading a printing material to the print nozzle 12 through a cold zone 16 and a hot zone 18. The head body 10 is operably connected to a 3D printing machine. More particularly, the invention provides that the upper part of the cold zone 16 of the print head is operably connected to the 3D printing machine.

According to such preferred embodiments, the print heads of the present invention further include a heating block 20 that is attached to the head body 10 (within the hot zone 18). In addition, according to certain preferred embodiments, the heating block 20 is directly connected to the body of the print nozzle 12. The invention provides that when the heating block 20 of the print head is affixed and attached to the head body 10 (and the print nozzle 12), such configuration enhances the mechanical strength of the print head. Such configuration also enables the use of a much larger heating block 20 (compared to various prior art print heads in which a heating block is mounted to a tube for guiding printing material). During operation, when using the print heads described herein, the temperature within the cold zone 16 may range from 30-degrees Celsius to 90-degrees Celsius; whereas, in the hot zone 18, the operating temperature may range from 70-degrees Celsius to 400-degrees Celsius. The invention provides that the heating block 20 may be made of aluminum, steel, stainless steel, copper, brass, and combinations and alloys of such materials.

The invention provides that at least one heating element (e.g., an electrical heating coil) is preferably mounted to or integrally formed within the heating block 20 (within the hot zone 18). The invention provides that parameters relating to the heating element (e.g., duration and amount of heat to be applied during a printing procedure) is preferably controlled through a user interface of the 3D printer. The hot zone 18 also preferably includes a temperature sensor, which is configured to monitor and report the temperature within the hot zone 18 to a processor and user interface associated with the 3D printer. The invention provides that the heating block 20 is preferably attached to the head body 10 using, e.g., screws, rivets, or other mechanical attachments, which preferably exhibit a small diameter (such as less than 1.5 mm) in order to minimize heat loss.

As illustrated in FIG. 1, and as mentioned above, the invention provides that the tube 14 extends through the cold zone 16, through the hot zone 18, and to the nozzle 12. Importantly, according to certain preferred embodiments of the present invention, the tube 14 and print nozzle 12 are integrally formed together (and are made from the same material), such that the tube 14 forms a single, seamless tunnel from the cold zone 16, through the hot zone 18, and to the print nozzle 12. In such embodiments, the tube 14 is preferably constructed without any joints (e.g., it is constructed without separate tubes adjoining each other, as otherwise included in various prior art printers), which eliminates the possibility of printing material leaks (which are sometimes observed in prior art print heads). In certain preferred embodiments, the integrally formed joint-free tube 14 and nozzle 12 are manufactured from metal materials. Non-limiting examples of such metals include steel, stainless steel, titanium, brass, copper, ceramic sinters, Teflon, and combinations and alloys of such metals. In such embodiments, the print head further includes a leading sleeve 28, which is positioned and configured to supply the printing material to the tube 14.

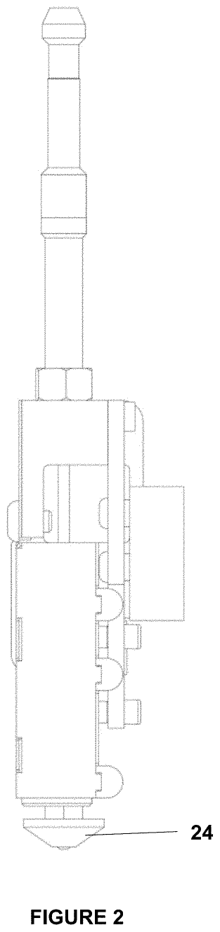

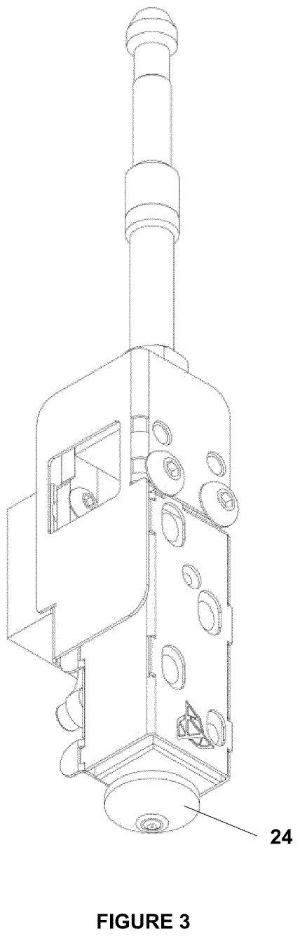

According to such preferred embodiments, the print heads of the present invention further include a heat shield 24, which is mounted to the print nozzle 12. More specifically, the heat shield 24 is mounted to the print nozzle 12, such that it forms a thermal barrier between the print head and a spatial model that is being printed below the print nozzle 12. The heat shield 24 may be constructed from, e.g., a polytetrafluoroethylene (PTFE) material. The invention provides that the heat shield 24 is configured to minimize the amount of disadvantageous heat radiation that emanates from the print head from contacting the spatial model being printed. That is, the heat shield 24, which is preferably positioned around the heating block 20, provides thermal insulation to the spatial model being printed. In certain embodiments, the heat shield 24 may exhibit a circular dimension, as illustrated in FIGS. 2 and 3.

Still further, according to certain preferred embodiments, the print head will include a screen 26 located around (and that encapsulates) the heating block 20. In such embodiments, the screen 26 is preferably made of a material with high thermal radiation insulation capacity, e.g., a metal having low heat capacity, low thermal conductivity, and high heat reflectivity. Non-limiting examples of such metals include steel, stainless steel, copper, brass, aluminum, and combinations and alloys of such metals.

The invention further provides that, within the cold zone 16, the joint-free tube 14 is preferably cooled by air flow. The invention provides that the portion of the tube 14 within the cold zone 16 is subject and exposed to free air flow. For example, the invention provides that one or a plurality of vents 30 may provide such air flow to that portion of the tube 14. In addition, in certain embodiments, the 3D printer may utilize and/or incorporate one or more fans (or other means) for generating air flow, which may preferably be applied to the cold zone 16 through the one or more vents 30.

The invention further encompasses 3D printers that include and are equipped with the print heads described herein. More particularly, the invention provides that the print heads may be constructed and sold separately or, in other embodiments, the invention encompasses 3D printers that include the print heads described herein.

There are many advantages of the print heads (and 3D printers) described herein. For example, as mentioned above, one advantage of the invention is that the construction of the print head prevents unwanted leaks of printing material (which cause print failures) within the seamless and joint-free tube 14 that spans both the hot zone 18 and cold zone 16. Another advantage is that the print head is configured to accommodate unique printing materials with associated operating temperatures that exceed 400-degrees Celsius (e.g., such print heads may accommodate metal and high-temperature polymer composite printing materials). In addition, the use of air ventilation within the cold zone 16 allows for effective removal of excess heat from the print head, while not compromising the ability of the printing material to be plasticized within the hot zone 18.

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A print head for 3D printers that comprises:
(a) a head body, which includes an internal cold zone and an internal hot zone;
(b) a print nozzle;
(c) a tube within the head body, wherein the tube is configured to receive and transport a printing material from a source within a 3D printer to the print nozzle, wherein the tube (i) spans the cold zone and the hot zone and (ii) does not include any joints or locations at which separate tubes connect; and
(d) a heating block, wherein the heating block is attached to the head body within the internal hot zone and directly to the print nozzle.

2. The print head of claim 1, which further comprises a screen that is positioned around and that encapsulates the heating block.

3. The print head of claim 2, wherein the screen is made of a material with high thermal radiation insulation capacity.

4. The print head of claim 1, wherein the tube and the print nozzle are integrally formed together from a single piece of material.

5. The print head of claim 4, wherein the tube and print nozzle are made from a metallic material.

6. The print head of claim 1, which further includes one or more vents that are positioned and configured to deliver air flow to a portion of the tube that resides within the cold zone.

7. A print head for 3D printers that comprises:
(a) a head body, which includes an internal cold zone and an internal hot zone;
(b) a print nozzle;
(c) a tube within the head body, wherein (i) the tube is configured to receive and transport a printing material from a source within a 3D printer to the print nozzle, (ii) the tube spans the cold zone and the hot zone and does not include any joints or locations at which separate tubes connect, and (iii) the tube and the print nozzle are integrally formed together from a single piece of metallic material;
(d) a heating block, wherein the heating block is attached to the head body within the hot zone and directly to the print nozzle;
(e) a screen that is positioned around and that encapsulates the heating block, wherein the screen is made of a material with high thermal radiation insulation capacity; and
(f) one or more vents that are positioned and configured to deliver air flow to a portion of the tube that resides within the cold zone.

8. A 3D printer that includes a print head, wherein the print head comprises:
(a) a head body, which includes an internal cold zone and an internal hot zone;
(b) a print nozzle;
(c) a tube within the head body, wherein the tube is configured to receive and transport a printing material from a source within a 3D printer to the print nozzle, wherein the tube (i) spans the cold zone and the hot zone and (ii) does not include any joints or locations at which separate tubes connect; and
(d) a heating block, wherein the heating block is attached to the head body.

9. The 3D printer of claim 8, which further comprises a screen that is positioned around and that encapsulates the heating block.

10. The 3D printer of claim 9, wherein the screen is made of a material with high thermal radiation insulation capacity.

11. The 3D printer of claim 8, wherein the tube and the print nozzle are integrally formed together from a single piece of material.

12. The 3D printer of claim 11, wherein the tube and print nozzle are made from a metallic material.

13. The 3D printer of claim 8, which further includes one or more vents that are positioned and configured to deliver air flow to a portion of the tube that resides within the cold zone.
